(19) United States
(12) Patent Application Publication
(10) Pub. No.: US 2026/0139745 A1
(43) Pub. Date: May 21, 2026

(54) ROTARY VALVE WITH ADJUSTABLE SEALING PRESSURE AND DEVICES COMPRISING SUCH VALVES

(71) Applicant: Quadrogen Power Systems, Inc., Burnaby (CA)

(72) Inventors: Robert Maillet, Burnaby (CA); Nelson Man Fai Chan, Burnaby (CA)

(73) Assignee: Quadrogen Power Systems, Inc., Burnaby, BC (CA)

(21) Appl. No.: 19/120,204

(22) PCT Filed: Oct. 12, 2023
(86) PCT No.: PCT/CA2023/051350

§ 371 Date: Apr. 10, 2025

Related U.S. Application Data
(60) Provisional application No. 63/415,870, filed on Oct. 13, 2022.

(51) Int. Cl. F16K 3/10; B01D 53/047; F16K 11/074

(52) U.S. Cl. CPC F16K 3/10; B01D 53/047; F16K 11/074; B01D 2259/40005

(57) ABSTRACT

A rotary valve comprises a housing and an end flange. The end flange comprises a pressure port and a through hole having first and second open ends and a threaded section between the ends. A rotor is rotatably mounted in the housing and comprises a contact surface. A stator is slidably mounted between the rotor and the end flange. The stator comprises a first side facing the contact surface of the rotor, and an opposite second side comprising a spring seat. A spring is received in the spring seat and the through hole on the flange. A spring tension adjuster threadedly engages the threaded section in the through hole and presses the spring towards the stator. The spring tension adjuster is configured to adjust a tension of the spring compressed between the stator and the end flange.

### CROSS-REFERENCE TO RELATED APPLICATION

This is the U.S. National Stage of International Application No. PCT/CA2023/051350, filed Oct. 12, 2023, which was published in English under PCT Article 21(2), which in turn claims the benefit of, and priority to U.S. Provisional Patent Application No. 63/415,870, filed on Oct. 13, 2022, the entire contents of which are incorporated herein by reference in their entirety.

### FIELD

The present disclosure relates generally to rotary valves with an adjustable sealing pressure, and particularly to rotary valves with spring-loaded pressure and sealing mechanisms for use in pressure swing adsorption applications and systems and devices including such valves.

### BACKGROUND

Pressure balanced rotary valves are useful in pressure swing adsorption (PSA) applications and systems. PSA has been employed in various gas separation and purification applications, such as separation or purification of biogas, field gas, syngas, waste hydrogen streams, and the like.

A typical rotary valve has a stator and a rotor that is rotatable relative to the stator around a rotation axis and is pressed against the stator. Each of the stator and rotor has ports thereon that can be aligned or offset depending on the relative rotational positions between the rotor and stator and rotor. When the rotor rotates, the stator and rotor remain in sliding and sealing contact under a pressure applied in the axial direction that biases the rotor and stator towards each other. This axial pressure is adjusted or balanced using biasing mechanisms such as springs that act on both the stator and rotor in some conventional rotary valves.

For example, U.S. Pat. No. 6,063,161 to Keefer et al. disclosed an example PSA system with multiport rotary valves, where the rotary valves are used to control the volume rates of gas flows to and from adsorbent beds in various steps of the PSA process.

U.S. Pat. No. 8,272,401 to McLean also disclosed a compact pressure balanced rotary valve for use in pressure swing devices, which includes variable loading pistons and fixed loading springs.

Additional rotary valves and their use in PSA systems are disclosed in, for example, U.S. Pat. Nos. 38,493, 4,272,265, 4,406,675, 4,452,612, 4,469,494, 4,758,253, 5,112,367, 5,133,784, 5,248,325, 5,256,174, 5,268,021, and 5,366,541.

However, conventional rotary valves such as those disclosed in U.S. Pat. No. 8,272,401 may still leak after a period of use and will require maintenance or replacement from time to time. Maintenance and replacement of the conventional rotary valves in a PSA system in turn require system downtime and expenses related to parts, labor, and other operational costs.

Thus, it is desirable to improve the existing rotary valves and provide rotary valves that are easier to maintenance and require less frequent replacement. It is also desirable to improve the existing rotary valves and provide rotary valves that are more convenient to use, install, operate, or maintain.

### SUMMARY

In accordance with an aspect of the present disclosure, there is provided a rotary valve comprising: a valve housing comprising a cylindrical channel and an end flange, the end flange comprising a pressure port and a through hole, the through hole having a first open end and a second open end and a threaded section between the first and second ends; a rotor rotatably mounted in the cylindrical channel of the valve housing and rotatable about a rotation axis, the rotor comprising a contact surface generally perpendicular to the rotation axis; a stator slidably mounted inside the valve housing between the rotor and the end flange, the stator comprising a first side facing the contact surface of the rotor and a second side opposite to the first side, the second side of the stator comprising a spring seat; a spring comprising a first end and a second end, the first end of the spring received in the spring seat of the stator, the second end of the spring received in the through hole of the end flange through the first open end of the through hole; a spring tension adjuster threadedly engaging the threaded section in the through hole of the end flange and pressing the spring towards the stator, the stator in turn biased by the spring towards the rotor, the spring tension adjuster being configured to be rotatable through the second open end of the flange to change an axial position of the spring tension adjuster so as to adjust a tension of the spring compressed between the stator and the end flange.

It is convenient to install, operate and maintain a rotary valve as described herein because the sealing pressure can be conveniently adjusted through the opening in the end flange without removing the valve from service and disassemble the valve itself.

In different embodiments, one or more of the following features may also be provided in a rotary valve described herein. For example, the stator may comprise a pressure port. Each one of the flange and the stator may comprise a plurality of pressure ports, and the rotary valve may comprise a plurality of pressure ports for biasing the stator towards the rotor. Each one of the rotor and stator may comprise a plurality of fluid ports. The rotary valve may comprise a plurality of springs and a plurality of corresponding spring tension adjusters. Each one of the springs may be positioned adjacent to one of the plurality of fluid ports and may be independently compressed by the corresponding spring tension adjuster. The spring tension adjuster may comprise a threaded stud. The spring tension adjuster may comprise an externally threaded tubing or sleeve. The rotary valve may comprise a seal compressed between the rotor and the stator. The spring tension adjuster may comprise stainless steel. The rotary valve may comprise a removable cap covering the second open end of the through hole.

In another aspect, there is provided a rotary valve comprising a valve housing comprising a cylindrical channel and an end flange, an inner side of the end flange comprising a spring pocket having an adjustable pocket length, the pocket length adjustable through an opening at an external side of the end flange; a rotor rotatably mounted in the cylindrical channel of the valve housing and rotatable about a rotation axis, the rotor comprising a contact surface generally perpendicular to the rotation axis; a stator slidably mounted inside the valve housing between the rotor and the end flange, the stator comprising a first side abutting the contact surface of the rotor and a second side opposite to the first side; and a spring received in the spring pocket and compressed between the end flange and the second side of the stator to bias the stator towards the rotor, wherein a tension in the spring is adjustable by adjusting the pocket length through the opening at the external side of the end flange.

In a further aspect, there provided a device comprising a housing comprising an input port and an output port; a plurality of adsorbent beds in the housing; a first rotary valve connecting the plurality of adsorbent beds to the input port for selectively communicating an input gas from the input port to a selected one of the plurality of adsorbent beds; a second rotary valve connecting the plurality of adsorbent beds to the output port for communicating an output gas from the selected one of the plurality of adsorbent beds to the output port. The first and second rotary valves comprise a rotary valve disclosed herein.

Other aspects, features, and embodiments of the present disclosure will become apparent to those of ordinary skill in the art upon review of the following description of specific embodiments in conjunction with the accompanying figures.

### BRIEF DESCRIPTION OF THE DRAWINGS

In the figures, which illustrate, by way of example only, embodiments of the present disclosure:

FIG. 1 is a schematic block diagram of a rotary valve, illustrating an embodiment of the present disclosure;

FIG. 2A is a schematic sectional view of an embodiment of the end flange in the rotary valve of FIG. 1, according to an embodiment of the present disclosure;

FIG. 2B is a top plan view of an example end flange, according to an embodiment of the present disclosure;

FIG. 2C is a bottom plan view of the end flange of FIG. 2B;

FIG. 3A is a perspective view of an embodiment of the spring tension adjuster in the rotary valve of FIG. 1, according to an embodiment of the present disclosure;

FIG. 3B is a bottom plan view of the spring tension adjuster of FIG. 3A;

FIG. 3C is a side elevation view of the spring tension adjuster of FIG. 3A;

FIG. 4A is a schematic sectional view of an embodiment of the stator with the seal in the rotary valve of FIG. 1, according to an embodiment of the present disclosure;

FIG. 4B is a top plan view of an example integrated stator and seal, according to an embodiment of the present disclosure;

FIG. 4C is a bottom plan view of the stator and seal of FIG. 4B;

FIG. 5 is a partial cross-sectional view of an embodiment of the rotary valve of FIG. 1, including an assembly of the example end flange of FIGS. 2B and 2C, a compression spring, the example spring tension adjuster of FIGS. 3A-3C, and the example stator and seal of FIGS. 4A-4C;

FIG. 6 is a cross-sectional view of a portion of another embodiment of the rotary valve of FIG. 1, with multiple compression springs;

FIGS. 7A and 7B are partial views of the portion of FIG. 6, showing the spring tension adjusters at different positions to adjust the length of (and thus tension in) the compression springs;

FIGS. 8A and 8B are partial views of the portion of FIG. 6, showing the spring tension adjusters at different positions to adjust the relative positions of the compression springs;

FIG. 9A is an exploded perspective view of a portion of rotary valve of FIG. 6;

FIG. 9B is an exploded sectional view of a portion of rotary valve of FIG. 6;

FIG. 10 is a schematic view of a pressure swing adsorption (PSA) system with rotary valves connected to multiple adsorbent beds, according to an embodiment of the present disclosure;

FIGS. 11A-11B are top and side views of an example spring tension adjuster, according to an embodiment of the present disclosure;

FIGS. 12A-12B are top and side views of another example spring tension adjuster, according to an embodiment of the present disclosure; and

FIGS. 13A and 13B are top and side views of a further example spring tension adjuster, according to an embodiment of the present disclosure.

### DETAILED DESCRIPTION

Example embodiments disclosed herein relate to rotary vales with spring loaded pressuring and sealing mechanisms.

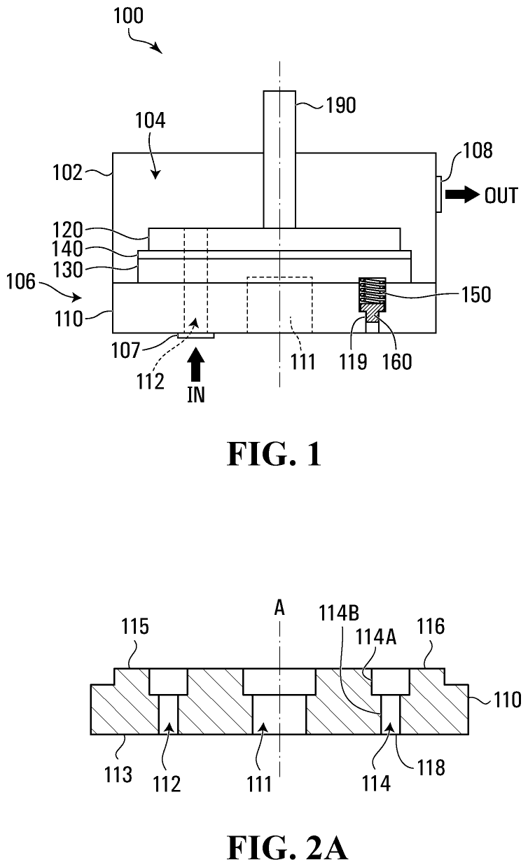

An embodiment is a rotary valve 100 as schematically illustrated in FIG. 1. Rotary valve 100 incudes a valve housing 102 having a cylindrical channel 104 for mounting other valve components therein with an open end 106, and an end flange 110 attached to the housing 102 at the open end 106. The housing also has an output port 108 and an input port 107. The input port may include one or more ports and may be provided on the flange 110 as described below.

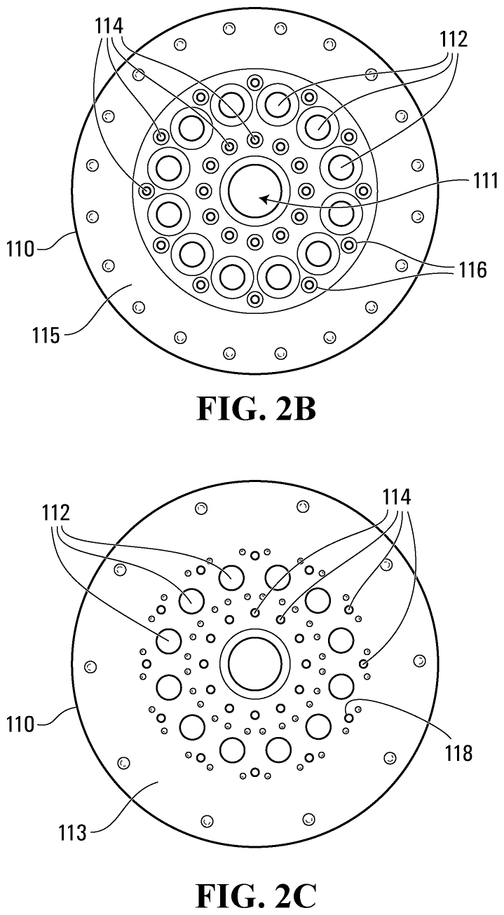

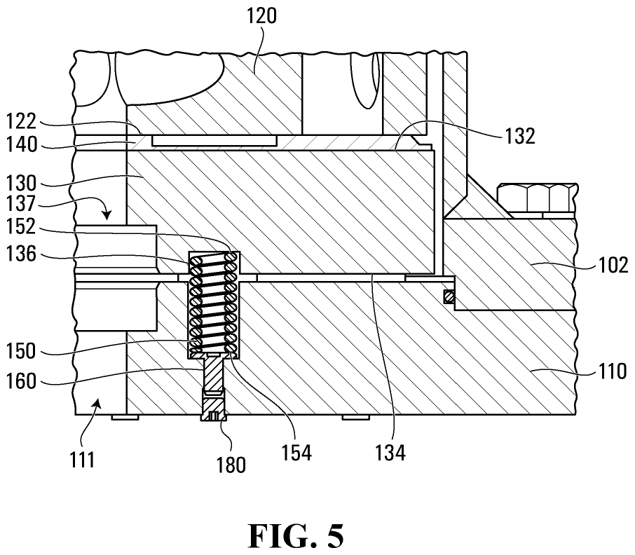

An example embodiment of the rotary valve 100 is partially shown in FIG. 5. In this example embodiment, the end flange 110, as can be better seen in FIGS. 2A to 2C, has a pressure port 111, a fluid port 112, and a through hole 114 extending from an external side 113 of the flange 110 to an inner side 115 of the flange.

The pressure port 111 is configured and used to apply a variable sealing pressure, as in a conventional face seal rotary valve and will be described further below. Port 111 may function as both inlet and outlet for tail gases.

The fluid port 112 may include one or more ports serving as the input ports.

The through hole 114 has a first open end 116 at the inner side 115, a second open end 118 at the external side 113, and a threaded section 119 between open ends 116, 118. End flange 110 servers as a packing flange as will become clear below. The open end 116 may have a cylindrical bore with a larger diameter than the diameter of the threaded section 119.

In some embodiments, as illustrated in FIGS. 2A-2C, each through hole 114 of the end flange 110 may include two sections with different diameters, as better illustrated in FIG. 2A. Specifically, the through hole 114 may include a thicker or enlarged section 114A for receiving the spring 150, which allows the spring to have a larger diameter size, and a thinner threaded section 114B for engaging the threaded spring tension adjuster 160.

In this embodiment, the threaded tension adjuster 160 may also include a threaded stud with an enlarged end 164 for abutting an end of the spring 150, as will be further described below. The enlarged end 164 allows better contact and support when the diameter of the threaded stud is smaller than the diameter of the spring 150, even when smaller than the inner diameter of a coiled spring. The enlarged end 164 may be flat or chamfered. The threaded tension adjuster 160 may be formed of stainless steel.

The end flange 110 may be removably attached to the valve housing 102 in any suitable manner, such as by bolts and nuts, according to conventional flange mounting or attachment techniques.

The end flange 110 may be formed of any suitable material for packing face seal rotary valves such as stainless steel.

A rotor 120 is rotatably mounted in channel 104 of the housing 102, and is rotatable about a rotation axis A. Rotor 120 comprises an inner contact surface 122 generally perpendicular to the rotation axis A and an opposite outer surface 124. One or more fluid ports 126 extend through rotor 110 between surfaces 122 and 124. The rotor may be connected to and actuated by a rotor shaft 190 for rotation. The rotor shaft 190 may be driven by a motor (not shown).

As can be appreciated, valve 100 may also include a different driving mechanism for rotating the rotor 120. The driving mechanism may be provided according to any known techniques and is thus not described in detail herein.

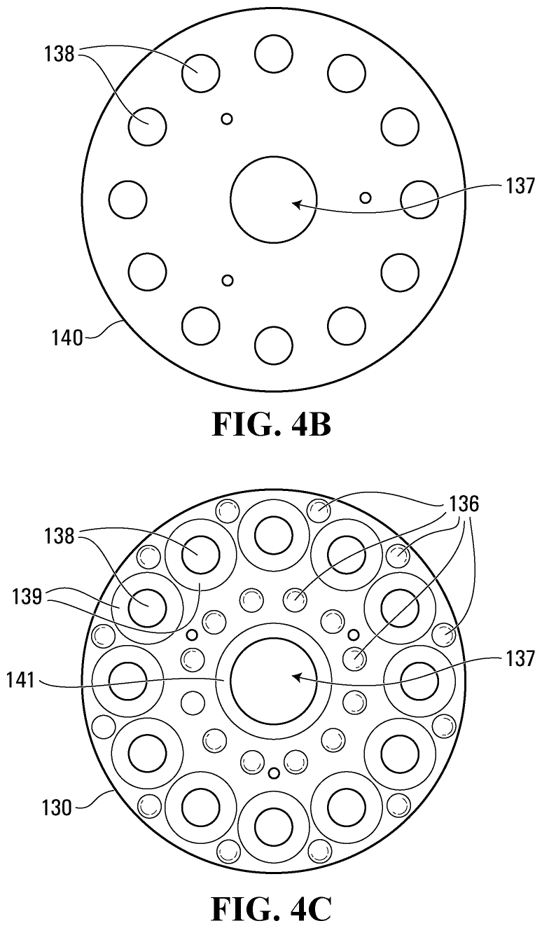

A stator 130 is slidably mounted inside the channel 104 of the valve housing 102 between the end flange 110 and the rotor 120. As depicted in FIGS. 1 and 4A-4C, the stator 130 has an inner side 132 that is facing the contact surface 122 of the rotor 120 and an outer side 134 opposite to the inner side 132 and facing the end flange 110. The outer side 134 of the stator 130 includes a spring seat 136, a pressure port 137, and a fluid port 138, which are positioned and sized corresponding to the through hole 114, pressure port 111, and fluid port 112 of the flange 110 respectively. Fluid port 138 may extend through stator 130 for selectively transporting fluid to a corresponding fluid port in the rotor 120. Pressure port 137 and fluid port 138 may each include an enlarged section, e.g. section 139 or section 141 as depicted in the drawings, for forming a half piston pocket to receive a corresponding pressure piston as further described below.

The stator 130 may be attached or mounted in the valve housing 102 in any suitable manner, such as being in contact and affixed relative to the flange 110. For example, the stator 130 may be affixed by welding or adhesive bonding to a stator housing (not shown). The stator 130 or its housing should be slidably and sealingly mounted in the valve housing 102 in such a way that there is no fluid path through any gap between the stator 130 and the housing wall of the housing 102, and the only fluid path to the rotor side of the rotary valve 100 is through the fluid ports 138 of the stator 130, and then fluid port 126 of the rotor 120. This sealing arrangement prevents undesired and uncontrolled gas leakage through the valve 100.

A seal 140 is provided and sandwiched between the inner contact surface 122 of the rotor 120 and the inner side 132 of the stator 130. In an embodiment, seal 140 may be integrated with stator 130 and provided on the inner surface 132 of stator 130, as illustrated in FIGS. 4A-4C. The seal 140 is compressed by rotor 120 and stator 130 and provides a fluid seal to prevent leakage of gases or liquids through the interface between the rotor 120 and stator 130 during operation, including when the rotor 120 is rotated relative to the stator 130 to open or close the valve 100. The pressure applied to the seal 140 is adjustable by a pressure or biasing force applied to the stator 130 as will be further described below. Optionally, in some embodiments the seal 140 may be provided as a separate layer. In other embodiments, the seal 140 may be a coating layer coated on, or a layer otherwise integrated with, either the inner surface 122 of rotor 120 or the inner side 132 of the stator 130.

The seal 140 may be formed of a low friction material. For example, seal 140 may include graphite, carbon, or polytetrafluorethylene (PTFE).

It can be understood that the respective materials for mating surfaces of the rotor and the stator or the seal, that are in sliding contact may include ceramic or hardened metal alloy for one of the two contacting surfaces and carbon or a self-lubricating polymeric compound for the other contacting surface, to minimize friction and wear.

As illustrated in FIG. 4B, the seal 140 may have corresponding openings that match the pressure port 137 and the fluid ports 138 on stator 130.

A compression spring 150, which may be a coil spring, is received in the through hole 114 of the end flange 110 and the spring seat 136 of stator 130. As depicted, a first end 152 of spring 150 is seated on the spring seat 136 of stator 130, and a second end 154 of spring 150 is in the through hole 114. Spring 150 extends through the first open end 116 of the end flange 110. Suitable example compression springs include heavy duty compression springs available from Associated Spring Raymond™, such as model number 106-510 (extra-heavy-duty die spring).

A spring tension adjuster 160, such as a threaded packing stud or threaded bolt, is threadedly engaged with the threaded section 114B in the through hole 114 of the end flange 110. The spring tension adjuster 160 is positioned to bias and press the spring 150 towards the stator 130. The spring 150 is thus compressed between the end flange 110 and the stator 130. At least a cylindrical or gland portion of the spring tension adjuster 160 is externally threaded to engage the threaded section 114B so that the spring tension adjuster 160 can be rotated to adjust the relative axial position of the adjuster 160 in the through hole 114. Changing the axial position of the spring tension adjuster 160 in the through hole 114 will increase or decrease the tension of the spring 150 compressed between the stator 130 and the end flange 110 by moving and repositioning the end 154 of spring 150 in the axial direction. Compressing the spring 150 also increases the force applied at the sealing surface.

As can be appreciated, the through hole 114 and the spring tension adjuster 160 in end flange 110 provide a spring pocket with an adjustable pocket length. The pocket length is adjustable through the opening at the second open end 118, which is at the external side of the end flange 114, by rotating the adjuster 160 with a hand tool such as a screwdriver.

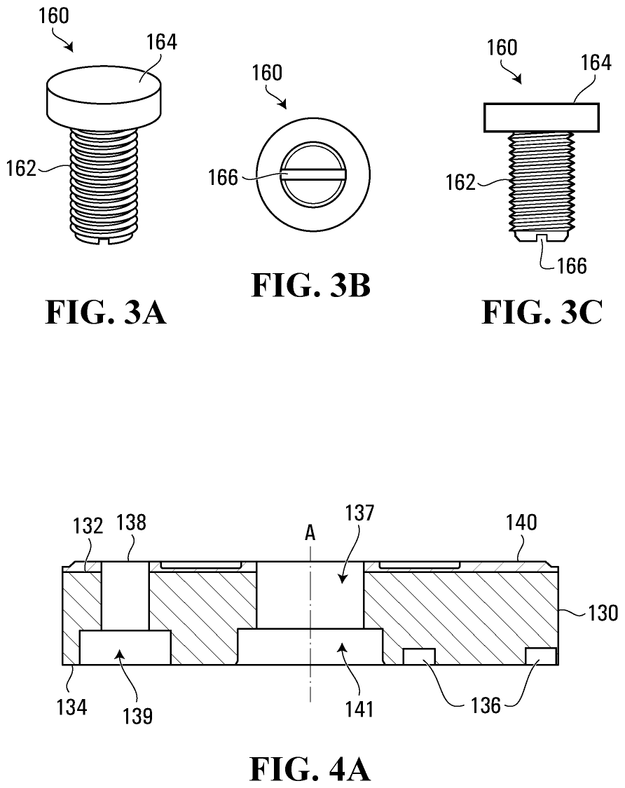

As illustrated in FIGS. 3A-3C, the spring tension adjuster 160 may be a threaded stud having a generally cylindrical body 162. The spring tension adjuster 160 may optionally have an enlarged end 164 for abutting the spring 150.

To facilitate rotating the spring tension adjuster 160 from the external side of the flange 110, the external end of the spring tension adjuster 160 may have a groove 166 configured to allow a tool such as a flat screwdriver (not shown) to be used to turn the spring tension adjuster 160 around its central axis as illustrated in FIGS. 3B and 3C.

In different embodiments, the groove 166 may be replaced by a different recess, such as crossed recesses or a hex bore so the spring tension adjuster 160 can be turned with a Philips or hex screwdriver or similar tool. In yet further embodiments, other types of screw heads or bolt heads may be provided at the external end for allowing a corresponding tool to apply a torque on the head to turn the spring tension adjuster 160.

In some embodiments, the spring tension adjuster 160 may include a straight cylindrical body having a threaded external surface.

A removable cap 180 may be provided to cover the open end 118 of the through hole 114, as illustrated in FIGS. 5, 7A, and 9A-9B.

An internal pressure is applied in the pressure port 111 and fluid port 112 for applying sealing pressures on the stator 130, and in turn onto the seal 140. The internal pressure also provides a biasing force to bias stator 130 towards the rotor 120 The fluid port 112 in the flange 110 and the fluid port 138 in the stator 130 are aligned and correspondingly configured to allow transport of fluids through the flange 110 and 130.

When the rotor 120 is rotated to a position such that the fluid port 138 of stator 130 is aligned with the corresponding fluid port 126 in the rotor 120, the rotary valve 100 is open and a fluid may flow therethrough. When the rotor 120 is rotated to a position such that the fluid port 138 of stator 130 is completely offset from the corresponding fluid port 126 in the rotor 120, the rotary valve 100 is closed and the fluid cannot flow therethrough the rotary valve 100.

A partial view of the above-described components as assembled is shown in FIG. 5.

As depicted, rotary valve 100 may include multiple pairs of pressure ports 112 in the flange 110 and the stator 130.

When multiple fluid ports are provided in a single rotary valve, the rotary valve may provide fluid paths for multiple fluid lines, which may be connected to, for example, multiple different reaction beds or vessels.

In rotary valve 100, at least one fluid path is provided, which extends through the rotor 120 and stator 130. In some embodiments of the rotary valves, a plurality of fluid paths may be provided.

An internal pressure can be applied to apply variable loading pressures or biasing forces onto the stator 130 for balancing purposes. The loading pressure or biasing force applied in a particular port may be dependent on the fluid pressure in the respective pressure port 112. The higher the fluid pressure, the larger the loading pressure or biasing force applied to the stator 130, and in turn, to the seal 140. Thus, a tighter seal at the seal interface between the rotor 120 and stator 130 results from a higher fluid pressure in the pressure port 112. The fluid pressures in different pressure ports 112 may be different or may be the same.

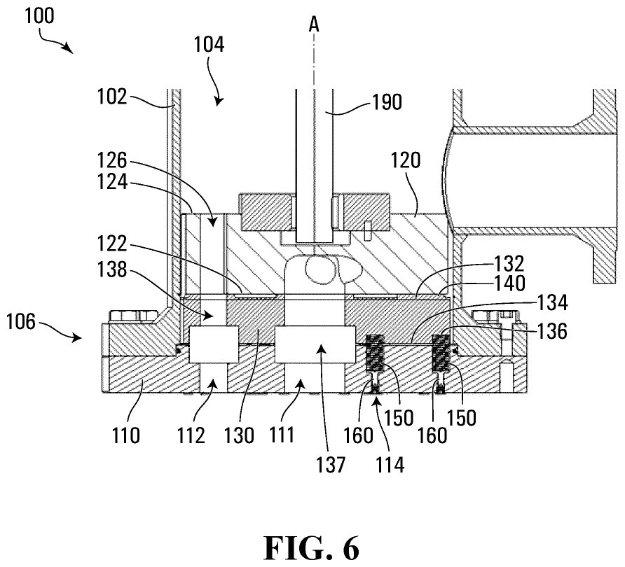

FIG. 6 shows a different embodiment of the rotary valve 100, with two or more compression springs 150.

As depicted, a plurality of springs and corresponding spring pockets may be provided in a rotary valve. For example, one of the springs 150 may be positioned adjacent to each fluid port and may be independently compressed by the corresponding spring tension adjuster (also see FIG. 2C and 4C.).

As now can be appreciated, valve 100 is a face seal rotary valve and has a pressure balanced rotary face seal between the rotor 120 and the stator 130.

The size and pitch of the threads on the threaded tension adjuster 160 and the threaded section may be selected depending on a number of factors and the particular application in which the valve 100 is to be used. The thread may be a standard fine thread according to the unified national fine (UNF) thread standards. With a fine thread, the stress on the low friction seal 140 can be fine-tuned and tailored for each application. Such fine-tuning and convenient adjustment of the stress during operation can reduce the wear and degradation of the seal material in the seal 140 and can provide optimal performance for different conditions and applications.

As illustrated, multiple springs 150 may be provided. Springs 150 may be provided at different distances from the central axis A of the stator 120.

In a pressure balanced rotary face seal, springs are a common method of applying activation force. This force is required to clamp the assembly closed, enabling sealing of the face. Determining this activation force can be difficult for dynamic applications. For example, while the proper activation force might be determined by trial and error using different springs of different strength or lengths, such determination would require repeated stopping and re-starting of the sealing and pressurization, and repeated disassembly and re-assembly of the pressure system and the rotary valve, which not only is inconvenient and time consuming, but also reduces production efficiency and increases the risks of introducing various system operation issues during this process.

In embodiments disclosed herein, multiple activation springs may be used, each being provided with a mechanical adjustment mechanism to adjust the spring tension by varying a pocket depth or length of the spring pocket in which the activation spring is mounted. The change in spring tension is controlled to vary or adjust the activation force and pressure applied by the spring to the seal interface. The mechanical adjustment mechanism is configured such that the depth or length of the spring pocket may adjusted through an end flange of the rotary valve in situ, without removing the valve from the operation system and disassembling the valve. The adjustment may be made using a simple tool, such as a driver similar to a screwdriver.

Conveniently, such adjustability allows a user or operator to dynamically change compressed length of the individual springs, and the compression force on, or the tension of, the individual spring, by conveniently turn or rotate a threaded tension adjustment member using the tool or driver.

With such adjustability, it is not necessary to replace the springs when the required biasing pressure on the seal interface is changed in order to use stiffer or softer springs to increase or decrease the applied pressure. As a result, it is not necessary to suspend or stop the production operation and disassemble of the assembly at the seal interface or remove the valve in order to change the biasing pressure applied by the spring to the stator. The adjustment can also be made relatively quickly and more conveniently.

Dynamically adjusting the spring compressed length, and the corresponding biasing pressure, allows the pressures applied to the seal interface being balanced and the balance being maintained over an extended period of time. For example, when a higher sealing or biasing force becomes required, such as due to physical wear, aging, or degradation of the materials at the sealing interface, the sealing or biasing force or pressure can be conveniently and quickly adjusted to apply increased sealing force or pressure.

In some embodiments and applications, the position of a seal spring may also be shifted, with or without changing the compressed length of the spring, so that the spring is relatively positioned closer or further away from the sealing interface. This adjustment may be convenient when, for example, the distance between the end flange and sealing interface is changed due to the above noted wear of the materials at the seal interface over time.

Fluid ports 112, 138 and 126 may be arranged in a circle (the port pitch circle) centred at axis A and spaced equidistant around the pitch circle, as illustrated in FIGS. 2B, 2C, 4B, and 4C. In the depicted embodiments, 12 different fluid paths are provided by the fluid ports.

As can be appreciated, smaller sized and evenly distributed pressure ports 112, coupled with multiple distributed compression springs 150, can provide improved pressure balancing, as compared to fewer larger-sized ports located at fewer pressure locations.

Also as indicated by the through holes 114 shown in FIGS. 2B and 2C (as well as the spring seats 136 shown in FIG. 4C), compression springs 150 may be located both inside and outside the port pitch circle for the fluid ports 112. Such arrangement of the compression springs 150 also provide improved balance of pressure.

The inside compression springs 150 may be arranged on an inner pitch circle centred at the central axis A and having a pitch circle diameter smaller than that of the port pitch circle, and the outside compression springs 150 may be arranged on an outer pitch circle centred at the central axis A and having a pitch circle diameter larger than that of the port pitch circle.

In some embodiments, the springs 150 on the inner pitch circle and outer pitch circle may be the same. In other embodiments, the springs 150 on the inner pitch circle may be different from those on the outer pitch circle. For example, an inner spring 150 may be tensioned to apply a less biasing or closing force to stator 130 than does an outer spring 150 for better balancing. The different spring tensions may be achieved by using springs with different sizes (diameter or length), different spring constants, or formed of different materials, or combinations thereof. Conveniently, the spring tension may be additionally or alternatively adjusted by the spring tension adjusters 160 as described herein.

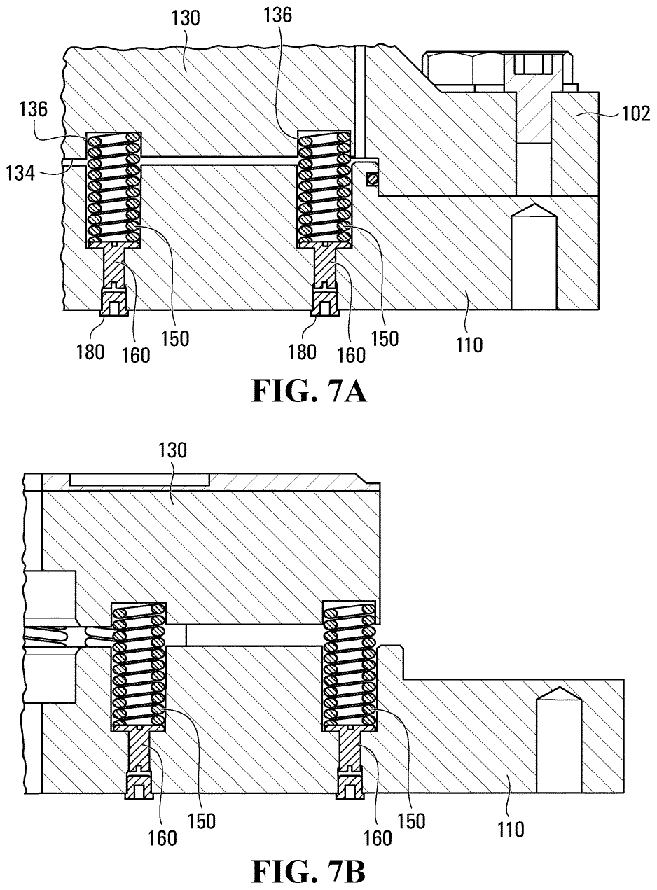

FIGS. 7A and 7B illustrate adjustment of the springs 150 by positioning the spring tension adjuster 160 at different axial locations. FIG. 7B shows the springs 150 at a minimum tension as the spring tension adjuster 160 is positioned at the bottom of the spring pocket and spring 150 is extended to its maximum length allowed by the distance between the flange 110 and stator 130. FIG. 7A shows that the springs 150 can be further compressed by positioning the spring tension adjuster 160 closer to the stator 130 so that the length of the spring is less than that shown in FIG. 7B. In both FIGS. 7A and 7B, the lengths of the springs 150 are less than their free length (or free height) so some tension is always present in the springs 150 during operation.

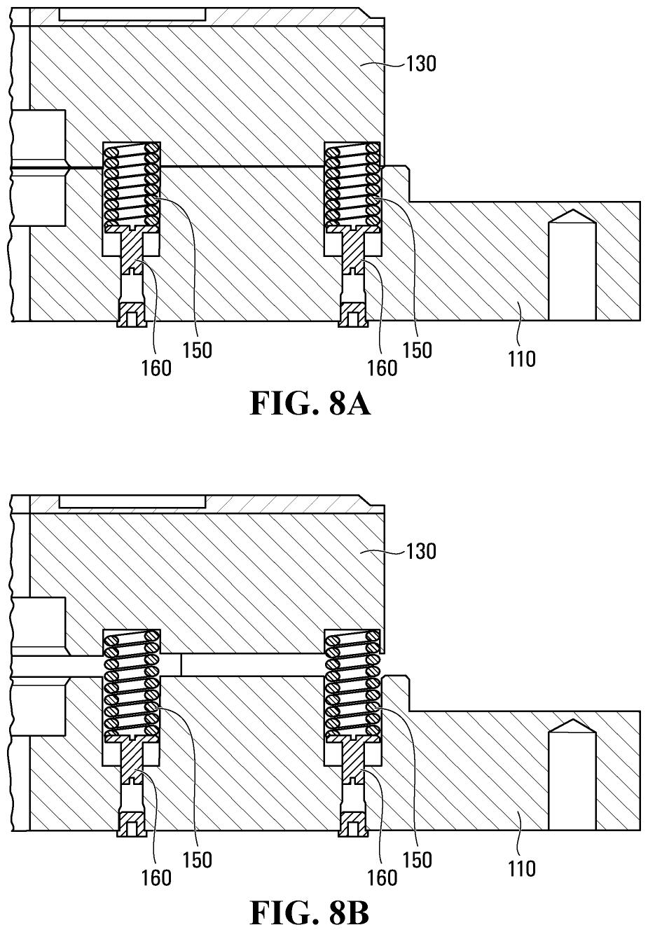

FIGS. 8A and 8B illustrate adjustment of the positions of the springs 150 by positioning the spring tension adjuster 160 at different axial locations, with or without changing the tension in the springs 150. FIG. 8A shows the springs 150 at a first position. FIG. 8B shows the springs 150 at a second position after the stator 130 has been moved upwards toward the rotor 120 slightly due to wear of the seal 140. However, in both FIGS. 8A and 8B, the work lengths (or work heights) of the spring 150 are the same by correspondingly adjusting the position of the spring tension adjuster 160 upwards by the same distance. As a result, the spring tension in both FIGS. 8A and 8B is the same even though the springs 150 is displaced due to movement of the stator 130.

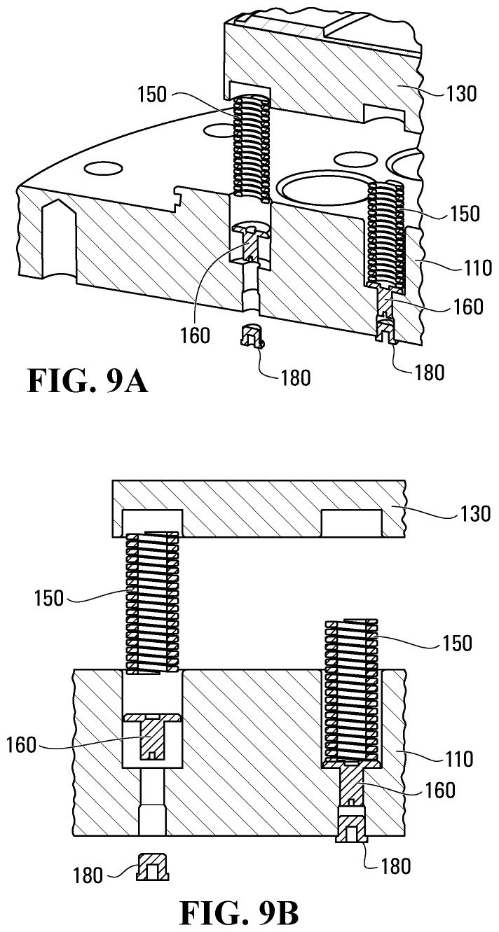

FIGS. 9A and 9B are exploded partial views of the flange 110, stator 130, spring 150, spring tension adjuster 160, and removable cap 180.

The example rotary valve 100 as depicted may be used for a PSA device comprising twelve (12) adsorbent beds.

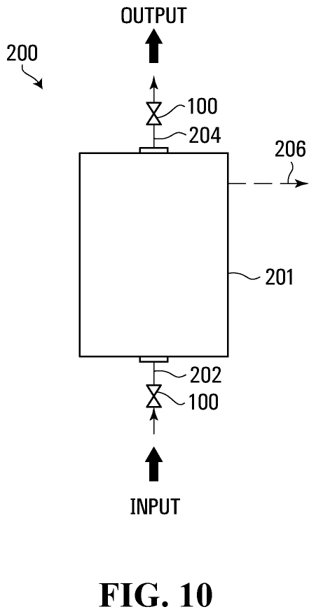

For example, as illustrated in FIG. 10, a PSA device 200 may include a number of adsorbent beds 201, such as 12 adsorbent beds (not separately shown), and two rotary valves 100. One of the rotary valves 100 is connected to a feed end 202 of the adsorbent beds 201 and another rotary valve 100 is connected to the output or product end 204 of the device 201. The feed end 202 may include 12 separate conduits (not separately shown) each in fluid communication with one of the 12 fluid ports 138 of the stator 130 in the rotary valve 100. The product end 204 may also include 12 separate conduits (not separately shown) each in fluid communication with one of the 12 fluid ports 138 of the stator 130 in the rotary valve 100 at the product end. The 12 conduits at each of the feed and product ends 202, 204 may be separately connected to the 12 adsorbent beds in the PSA device 200 respectively, thus forming a fluid path connecting respective ones of the fluid ports 138 of the two rotary valves 100 through a corresponding adsorbent bed (not shown) in the PSA device 200. PSA device 200 may optionally include other fluid ports such as output port 206.

Those skilled in the art will appreciate that different embodiments of a rotary valve as described herein may be configured or modified for application in PSA devices having a different number of adsorbent beds, or in other chemical processing systems having any number of reaction vessels.

In different embodiments the fluid ports and pressure ports in the rotary valves may have different shapes and may be located on different port pitch circles.

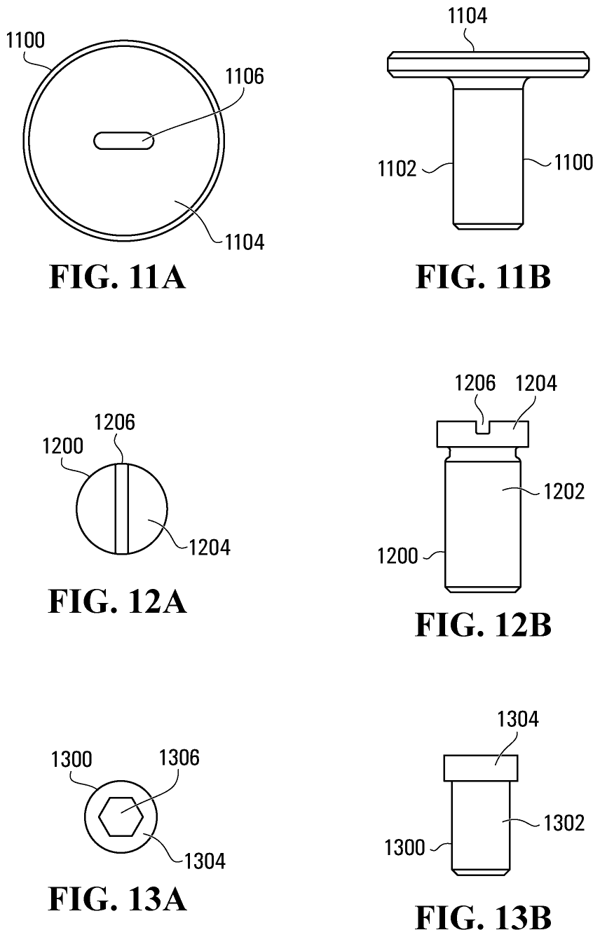

FIGS. 11A-13B illustrate different embodiments of the spring tension adjuster 160. For example, a spring tension adjuster 1100 may include a threaded stud 1102 with an anchor head 1104, as illustrated in FIGS. 11A and 11B. A spring tension adjuster 1200 may also include a threaded bolt 1202 with a bolt head 1204, as illustrated in FIGS. 12A and 12B. FIGS. 13A and 13B illustrate another spring tension adjuster 1300 with a bolt 1302 and a bolt head 1304. The anchor head 1104, bolt head 1204, or bolt head 1304 may include a corresponding coupling portion 1106, 1206, or 1306 for turning the adjuster with a suitable tool. The spring tension adjuster 160 may alternatively include a tubing or sleeve with external threads and a solid external end or head for turning by a suitable tool.

As can now be appreciated, embodiments disclosed herein utilizes mechanical spring tension adjusters to increase or decrease the tension or position of the compression springs used to apply additional sealing pressure or force to the sealing interface between the rotor and stator of a face seal rotary valve. This changing spring pocket gives infinite adjustability to the seal interface pressure allowing for optimum sealing performance and long life, while minimizing down time and eliminating the need for disassembly and reassembly.

In a typical pressure swing adsorption process, different gases in a gas stream may be separated by passing the gas stream containing a mixture of the different gases over an adsorbent, typically placed in an adsorbent bed, where under a selected pressure the adsorbent preferentially adsorbs one or some of the component gases in the mixture without substantially adsorbing at least one other of the component gases in the mixture. The non-adsorbed component(s) can then be recovered as a product gas steam. The pressure on the adsorbent can then be reduced to release (i.e., desorb) the adsorbed component(s), which can then be collected and recovered as another product gas stream. The adsorbent may be regenerated and purged after a production cycles and be re-used in another adsorption-desorption cycle.

The rotary valve assembly in a PSA system may include one or more rotor/stator pairs, each having a plurality of circumferentially arranged apertures, referred to as fluid ports, which are configured and positioned to allow for synchronized fluid communication between regions of an adsorbent bed separated by the rotor/stator pairs. The fluid ports may be selected so they are of effective sizes and effective shapes to allow balancing of fluid flows and control of fluid flow rates, by adjusting the relative rotational speeds of the rotor/stator pairs.

A rotary pressure swing (PSA) device may include, for example, a rotor connected to or provided with a plurality of adsorbent beds, a stator having a plurality of conduits serving as fluid ports, and a seal positioned between the rotor and the stator.

In different embodiments, a rotary valve disclosed herein may be used in any swing adsorption system or process. For example, the swing adsorption process may be any of the following types of pressure swing adsorption: pressure swing adsorption (PSA), partial pressure swing adsorption (PPSA), rapid cycle pressure swing adsorption (RCPSA), rapid cycle partial pressure swing adsorption (RCPPSA), vacuum pressure swing adsorption (VPSA), or the like. The swing adsorption process may also be temperature swing adsorption (TSA), rapid cycle thermal swing adsorption (RCTSA), or a pressure/temperature swing adsorption.

A swing adsorption process may occur in a cylindrical vessel containing a plurality of adsorbent beds. The individual adsorbent beds may be at different stages of a production or adsorption cycle, which may include a pressurization/adsorption stage, one or more depressurization/desorption stages, one or more blow-down stages, and one or more re-pressurization stage. The flow of fluid to and from each adsorbent bed may be controlled by use of a suitable valve, including a rotary valve. The rotary valve may be configured as disclosed herein.

A rotary valve disclosed herein can also be used to provide an efficient way of combining or integrating multiple process valves required for repetitive chemical processing cycles in a single vessel in various applications. Rotary valves disclosed herein may also be used in various chemical processing operations involving pressure swing processes or apparatuses. For example, multiple reaction sites, such as adsorbent beds or catalyst beds, in a single vessel may be associated by a single rotor/stator pair with multiple ports, and the rotor and stator may be operated at different speeds of rotation to provide the desired fluid flows.

Cyclic adsorption processes may also be performed in one or more adsorption vessels filled with adsorbents. Two or more vessels may be optionally arranged in parallel and time-synched such that at least one vessel is at the adsorption stage when at least one other vessel is at the adsorbent regeneration stage. In each cycle of the process a series of sequential stages, such as adsorption, equalization and regeneration, are carried out in each vessel. To enable the various streams to flow to and from the vessels, the feed, product, and exhaust lines may be provided with a rotary valve as described herein for controlling and regulating the gas flow through these lines at the appropriate time in the adsorption cycle. A rotary valve as described herein may also be used to allow and control fluid communication between multiple inlets and outlets of the same or different vessels, such as during pressure equalization stages.

A rotary valve as described herein may be used with any suitable adsorption bed for the separation of a target gas form a gaseous mixture.

The PSA system may be configured and constructed according to any suitable known technology. For example, the adsorbent beds in a suitable PSA system may include beds of beaded or pelletized adsorbent particles or an adsorbent material on a structured contactor, such as a parallel channel contactor. The contactors may contain substantially parallel flow channels. The adsorbent may be incorporated into the wall of a flow channel.

In some embodiments, the rotor of the rotary valve may be configured to rotate with an associated adsorbent bed. In some embodiments, the rotor of the rotary valve may rotate but the associated adsorbent bed(s) may remain stationary when the rotor of the rotary valve rotates.

In different embodiments, the rotor 120 may have a number of fluid ports 126 used for different functions. For example, the fluid ports 126 of a rotor 120 may include one or more feed ports, a counter-current blowdown port, and a purge exhaust port, as can be understood by those skilled in the art. The fluid ports 126 of a rotor 120 may alternatively include one or more product ports, fluid withdraw ports, or fluid return ports.

It should be understood that while the inner surface or side of the rotor and stator shown in the drawings are depicted as flat and planar surfaces or sides, in different embodiments, the contact surfaces or sides between the rotor and stator, and the seal interface or layer between the rotor and stator, may be of a different geometry. For example, the contact surfaces and the seal layer may be sloped, such as cone-shaped, or may be shaped like cylinders or be other surfaces of revolution.

The rotary valves and PSA devices disclosed herein may be used for different applications, such as hydrogen separation, air separation, oxygen production, and for other gas or vapor separations. For example, they may be used in applications for hydrogen recovery from refinery off-gases or a syngas, or for hydrogen purification applications.

It should also be understood that modifications and variations to the specific embodiments described above are possible.

### Concluding Remarks

It is to be understood that the figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the subject matter disclosed herein.

In addition, any specific numerical value listed herein includes a margin of error of +/−10%.

In the present disclosure, terms such as “horizontal” and “flat” do not necessarily require the relevant structure be perfectly horizontal or flat. Instead, these terms are intended to encompass structure that is generally and sufficiently horizontal or flat, for example, so as to function essentially the same as structure that is perfectly horizontal or flat.

It will be understood that any range of values herein is intended to specifically include any intermediate value or sub-range within the given range, and all such intermediate values and sub-ranges are individually and specifically disclosed.

It will also be understood that the word “a” or “an” is intended to mean “one or more” or “at least one”, and any singular form is intended to include plurals herein.

It will be further understood that the term “comprise”, including any variation thereof, is intended to be open-ended and means “include, but not limited to,” unless otherwise specifically indicated to the contrary.

When a list of items is given herein with an “or” before the last item, any one of the listed items or any suitable combination of two or more of the listed items may be selected and used.

Of course, the above described embodiments of the present disclosure are intended to be illustrative only and in no way limiting. The described embodiments are susceptible to many modifications of form, arrangement of parts, details and order of operation. The invention, rather, is intended to encompass all such modification within its scope, as defined by the claims.

1. A rotary valve comprising:
a valve housing comprising a cylindrical channel and an end flange, the end flange comprising a pressure port and a through hole, the through hole having a first open end and a second open end and a threaded section between the first and second ends;
a rotor rotatably mounted in the cylindrical channel of the valve housing and rotatable about a rotation axis, the rotor comprising a contact surface generally perpendicular to the rotation axis;
a stator slidably mounted inside the valve housing between the rotor and the end flange, the stator comprising a first side facing the contact surface of the rotor and a second side opposite to the first side, the second side of the stator comprising a spring seat;
a spring comprising a first end and a second end, the first end of the spring received in the spring seat of the stator, the second end of the spring received in the through hole of the end flange through the first open end of the through hole;
a spring tension adjuster threadedly engaging the threaded section in the through hole of the end flange and pressing the spring towards the stator, the stator in turn biased by the spring towards the rotor, the spring tension adjuster being configured to be rotatable through the second open end of the flange to change an axial position of the spring tension adjuster so as to adjust a tension of the spring compressed between the stator and the end flange.

2. The rotary valve of claim 1, wherein the stator comprises a pressure port.

3. The rotary valve of claim 1, wherein each one of the flange and the stator comprises a plurality of pressure ports, and the rotary valve comprises a plurality of pressure ports for biasing the stator towards the rotor.

4. The rotary valve of claim 1, wherein each one of the rotor and stator comprises a plurality of fluid ports.

5. The rotary valve of claim 4, comprising a plurality of springs and a plurality of corresponding spring tension adjusters.

6. The rotary valve of claim 5, wherein each one of the springs is positioned adjacent to one of the plurality of fluid ports and is independently compressed by the corresponding spring tension adjuster.

7. The rotary valve of claim 1, wherein the spring tension adjuster comprises a threaded stud.

8. The rotary valve of claim 1, wherein the spring tension adjuster comprises an externally threaded tubing or sleeve.

9. The rotary valve of claim 1, comprising a seal compressed between the rotor and the stator.

10. The rotary valve of claim 1, wherein the spring tension adjuster comprises stainless steel.

11. The rotary valve of claim 1, comprising a removable cap covering the second open end of the through hole.

12. A rotary valve comprising:
a valve housing comprising a cylindrical channel and an end flange, an inner side of the end flange comprising a spring pocket having an adjustable pocket length, the pocket length adjustable through an opening at an external side of the end flange;
a rotor rotatably mounted in the cylindrical channel of the valve housing and rotatable about a rotation axis, the rotor comprising a contact surface generally perpendicular to the rotation axis;
a stator slidably mounted inside the valve housing between the rotor and the end flange, the stator comprising a first side abutting the contact surface of the rotor and a second side opposite to the first side; and
a spring received in the spring pocket and compressed between the end flange and the second side of the stator to bias the stator towards the rotor, wherein a tension in the spring is adjustable by adjusting the pocket length through the opening at the external side of the end flange.

13. A device comprising:
a housing comprising an input port and an output port;
a plurality of adsorbent beds in the housing;
a first rotary valve connecting the plurality of adsorbent beds to the input port for selectively communicating an input gas from the input port to a selected one of the plurality of adsorbent beds;
a second rotary valve connecting the plurality of adsorbent beds to the output port for communicating an output gas from the selected one of the plurality of adsorbent beds to the output port;
wherein the first and second rotary valves comprise the rotary valve of claim 1.
